(19) United States
(12) Patent Application Publication
(10) Pub. No.: US 2009/0230113 A1
(43) Pub. Date: Sep. 17, 2009

(54) HEATED FLOOR SUPPORT STRUCTURE AND METHOD OF INSTALLING

(76) Inventor: Imre Batori, Fairfax, VA (US)

Correspondence Address: FITCH EVEN TABIN & FLANNERY, 120 SOUTH LASALLE STREET, SUITE 1600, CHICAGO, IL, 60603-3406, US

(21) Appl. No.: 12/409,194

(22) Filed: Mar. 23, 2009

Related U.S. Application Data
(63) Continuation-in-part of application No. 12/040,607, filed on Feb. 29, 2008.

(51) Int. Cl. H05B 3/00; E04B 5/48

(52) U.S. Cl. 219/213; 52/745.05

(57) ABSTRACT

A support structure includes a surface portion and a first protrusion that extends from the surface portion. The first protrusion has a first base portion extending from the surface portion the first base portion defining a first upper portion. The first upper portion overhangs the first base portion. A second protrusion extends from the surface portion. The second protrusion is adjacent to the first protrusion. The second protrusion has a second base portion extending from the surface portion and defines a second upper portion. The second upper portion overhangs the second base portion. The first upper portion and the second upper portion are separated by a distance. A heating conductor has a diameter and the diameter is the same or greater than the distance. The heating conductor is configured to snap into a passageway via the formed between the first protrusion and the second protrusion.

### CROSS REFERENCES TO RELATED APPLICATIONS

This application is a continuation-in-part of application Ser. No. 12/040,607 filed Feb. 29, 2008, entitled “Heated Floor Support Structure,” and naming Imre Batori as inventor, the disclosure of which is incorporated herein by reference in its entirety.

### FIELD OF THE DISCLOSURE

The disclosure of the present application relates to support structures for floors, in particular, support structures for floors that also support heating cables.

### BACKGROUND

Traditionally, the flooring industry has successfully used an anti-fracture uncoupled support structure disposed between an underlying subfloor and a main floor to protect the main floor from cracking or failing as the subfloor shifts and settles. The support structure decouples the subfloor from the main floor, thereby isolating the subfloor movement from the main floor. Main floors made up of tile are particularly vulnerable to the effects of such subfloor movement.

FIG. 1 shows an example of a commonly-used support structure, as reproduced from and described in U.S. Pat. No. 6,434,901 by Schluter. Schluter describes a support plate made of a foil-like plastic material with protrusions that extend from the material in at least two orientations and intersect to form cavities. The support plate lies between a subfloor and a main floor and decouples the subfloor from the main floor. The support plate is attached to the subfloor with a type of adhesive, e.g., mortar, through a webbing on the underside of the plate. The support plate is filled and covered with mortar to hold the main floor thereon.

In recent years, heated flooring has become popular, in which heating structures are installed beneath the main floor to support heating cables that provide heat. In most cases, an electric heating cable is laid in the heating structure in a typical back-and-forth pattern underneath the area of the main floor to be heated. The heating cable is connected to a thermostat that provides temperature control. A common heating structure is a mat that has the heating cable build into the mat or between two layers of the mat glued together. Examples of such mats are provided by Nuheat™, SunTouch™, Thermosoft™, Warmly Yours™, and WattsRadiant™. However, since used with the support structure, such mats make up another layer to be added between the subfloor and the main floor. The construction of such multiple layers can result in added cost and installation time. Such multiple floor layers can also result in an uneven main floor caused by the elevation difference between the heated areas that include the mats and the unheated areas that do not. Moreover, with irregular shaped rooms or pipes and vents that protrude into the floor, such mats may require customization to properly cover the desired floor area. Such customization comes at substantial cost and required lead time. If changes occur to the floor after a customized mat is created, the customized mat must be modified. This is problematic because the customized mat cannot be modified easily and cannot be so modified without voiding the mat's warranty. Since changes in floor design frequently occur during construction, it then becomes necessary to either modify the customized mat or order a new one.

As an alternative to mats, the flooring industry has introduced another heating structure, cable strips, for laying heating cable. Cable strips are narrow plastic (or similar material) strips that include holders at spaced intervals to hold a cable. The strips are laid along the perimeter of the floor area to be heated. A heating cable is then strung in a typical back-and-forth pattern across the floor area between the cable strips and placed in the strips' holders at the floor perimeter. Examples of such cable strips are provided by Nuheat™ and Flextherm™. These cable strips provide a flexible arrangement for any shape of floor, thereby avoiding the customization sometimes required for mats. However, such cable strips can leave portions of the heating cable exposed on top of the floor. Also, the cables can be difficult to bond properly to the subfloor. In additional, like the mats, such strips can result in an uneven main floor caused by the elevation difference between the heated floor areas that include the cable and cable strips and the unheated floor areas that do not. Also, like the mats, since used with the support structure, the cable and cable strips make up another layer to be added at additional cost and installation time.

As another alternative, panels have been introduced as heating structures for laying heating cable. One such panel is described in WO 02/37032 by Altepost, which describes a modular heating panel having a flat rectangular base body and cavities in a grid-like channel configuration for holding thermal conduits. Another such panel is described in U.S. D541,396 by Fawcett, which describes a radiant heat floor panel having flower-shaped elements and channels around and between the elements through which thermal elements run. Another such panel is manufactured by Schluter™, which has circular elements spaced apart by channels through which heating tubes run. Another such panel is described in U.S. Pat. No. 6,539,681 by Siegmund, which describes a spacer plate having spacers on the bottom of the plate to form a hollow floor and grooves in the top surface of the plate to hold heating or cooling pipes. These panels provide a quick way to cover large areas with heating elements. However, like mats, such panels may make up another layer, in addition to the support structure, to be added at additional cost and installation time. As before, there may also be the uneven main floor possibility with the added panel layer.

Accordingly, there is a need for an effective way to lay cables that avoids the above-mentioned drawbacks.

### SUMMARY

In order to provide an effective way to lay cables, the present disclosure teaches a support structure that combines the established functionality of both a commonly used support structure and a commonly used heating structure into a single structure that supports a floor to prevent fracture and failure and also supports a heating cable to heat the floor. As such, the need for a separate heating structure is eliminated. This results in a simpler, less expensive, and more effective floor support structure than those commonly used.

For example, the support structure may include protrusions extending from the surface of the structure, cavities formed between the protrusions, and openings or slots adjacent to the protrusions to form pathways to adjacent cavities. The structure's protrusions and cavities may then provide the floor support. The structure's openings and cavities may then provide placement for heating cables. In some examples, the support structure may be included in a cable system that also includes a cable supported by the structure.

The methods of the present disclosure may include a method for supporting a cable in the support structure and a method for making the support structure. In addition a kit containing the support structure is provided as is a method for installing the support structure over an existing flooring system.

In many of these embodiments, a support structure includes a surface portion and a first protrusion that extends from the surface portion. The first protrusion has a first base portion extending from the surface portion the first base portion defining a first upper portion. The first upper portion overhangs the first base portion. A second protrusion extends from the surface portion. The second protrusion has a second base portion extending from the surface portion and defines a second upper portion. The second upper portion overhangs the second base portion. The second upper portion is adjacent to the first upper portion and is separated from the first upper portion by a distance. A heating conductor has a diameter and the diameter is the same or greater than the distance. The heating conductor is configured to snap into a passageway via the formed between the first protrusion and the second protrusion.

### DESCRIPTION OF THE DRAWINGS

FIG. 1 is a diagram of a three-dimensional view of an example of a commonly used support structure.

FIG. 2 comprises a diagram of a top view of an example of a support structure according to various embodiments of the present invention;

FIG. 3 comprises a diagram of a three-dimensional view of an example of the support structure of FIG. 2 along section line A-A according to various embodiments of the present invention.

FIG. 4 comprises a diagram of a side view of an example of the support structure of FIG. 2 along section line A-A according to various embodiments of the present invention.

FIG. 5 comprises a diagram of a top view of an example of the support structure of FIG. 2 with cables supported therein according to various embodiments of the present invention.

FIG. 6 is a diagram of a top view of an example of a support structure with single diagonal slots according to various embodiments of the present invention.

FIG. 7 is a diagram of a top view of an example of the support structure of FIG. 6 with cables supported therein according to various embodiments of the present invention.

FIG. 8 is a diagram of a top view of an example of a support structure with curved protrusions and slots according to various embodiments of the present invention.

FIG. 9 is a diagram of a top view of an example of the support structure of FIG. 8 with cables supported therein according to various embodiments of the present invention.

FIG. 10 is a diagram of a top view of an example of a support structure with triangular cavities according to various embodiments of the present invention.

FIG. 11 is a diagram of a top view of an example of the support structure of FIG. 10 with cables supported therein according to various embodiments of the present invention.

FIG. 12 is a diagram of a top view of an example of a support structure with circular cavities according to various embodiments of the present invention.

FIG. 13 is a diagram of a top view of an example of the support structure of FIG. 12 with cables supported therein according to various embodiments of the present invention.

FIG. 14 is a diagram of an example of an installed floor including the support structure of FIG. 2 according to various embodiments of the present invention.

FIG. 15 comprises a cross sectional view of another example of a support structure according to various embodiments of the present invention.

FIG. 16 comprises a perspective view of an example of a support structure according to various embodiments of the present invention.

FIG. 17 comprises a cross sectional view of another example of a support structure according to various embodiments of the present invention.

FIG. 18 comprises a cross sectional view of another example of a support structure according to various embodiments of the present invention.

FIG. 19 comprises a perspective view of one example of a support structure according to various embodiments of the present invention.

FIG. 20 comprises a flowchart describing one example of a method of installing the floor structure according to various embodiments of the present invention.

### DETAILED DESCRIPTION

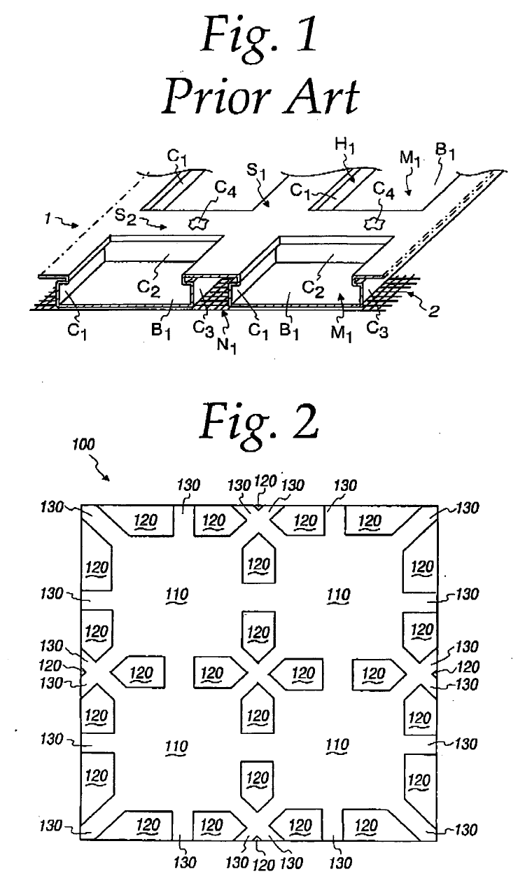

The present disclosure teaches a floor support structure that provides protrusions extending from the structure surface to form cavities and slots adjacent to the protrusions to provide pathways to the cavities. These slots support heating cables in the way that, traditionally, a separate heating structure does. As such, the traditional separate heating structure is eliminated. The support structure also maintains its established function to flexibly support a main floor in order to prevent fractures or failures due to movement of an underlying subfloor. The result is a simpler, less expensive, and more effective support structure that provides at least the same or a similar level of performance as the commonly used support structure of FIG. 1 and the commonly used heating structure of mats, cable strips, panels, and so forth.

FIG. 1 is a diagram of an example of the commonly used support structure as described in U.S. Pat. No. 6,434,901 by Schluter. In FIG. 1, support plate 1 provides the established function of decoupling an underlying subfloor from a main floor to prevent the main floor from fracture and failure as the subfloor shifts and settles. The support plate 1 includes protrusions N₁, N₂, S₁, and S₂ that extend upward and run in horizontal and vertical directions to intersect at right angles to form cavities M₁ between the protrusions N₁, N₂, S₁, and S₂. Each cavity M₁ has a rectangular shape with a base region Bi and four side regions C₁-C₄. Each cavity M₁ also has an undercut H₁ disposed about the periphery of the cavity M₁ and overhanging the cavity M₁ as part of the protrusions N₁, N₂, S₁, and S₂, such that the protrusions N₁, N₂, S₁, and S₂ have a T-shaped cross-section. The plate 1 has a webbing 2 on the underside. Upon installation, the cavities M₁ are filled with a filler, e.g., mortar, and the plate 1 covered with the filler in order to hold the main floor. The webbing 2 is disposed in adhesive, e.g., mortar, to attach the plate 1 to the subfloor.

Other examples of the commonly used support structure are also described in U.S. Pat. No. 6,434,901 by Schluter, as mentioned previously.

As seen in FIG. 1, support plate 1 is not configured to support a heating cable. As such, for heated flooring, a heating structure to support the heating cable is needed as an additional layer between the subfloor and the main floor. As described above, such heating structures, e.g., mats, cable strips, and panels, are problematic for the reasons previously mentioned.

FIG. 2 is a diagram of a top view of an example of a support structure according to the present disclosure that is different from the commonly used support structure of FIG. 1. In FIG. 2, support structure 100 combines the function of decoupling an underlying subfloor from a main floor to prevent main floor fracture or failure with the function of supporting heating cables for heated flooring. The support structure 100 includes protrusions 120 that extend upward and run in horizontal and vertical directions at right angles to form cavities 110 between the protrusions 120. Each cavity 110 has a rectangular shape with a base region defined by the locations of the surrounding protrusions 120 and side regions formed of the protrusions 120. Optionally, each cavity 110 can also have an undercut (not shown) disposed about the periphery of the cavity 110 and overhanging the cavity 110 as part of the protrusions 120, such that the protrusions 120 have a T-shaped cross-section. The support structure 100 has slots 130 made adjacent to the protrusions 120. The slots 130 are oriented horizontally, vertically, and/or diagonally adjacent the protrusions 120 and provide pathways to adjacent cavities 110. The depth of the slots 130 measures from the tops of the protrusions 120 to the floor of the cavities 110. A difference between the commonly used support structure of FIG. 1 and the support structure of FIG. 2 according to the present disclosure is the presence of the slots 130, which vertically and horizontally bisect the protrusions of FIG. 1 and diagonally bisect the intersections of the protrusions of FIG. 1.

There are many advantages of the support structure according to the present disclosure. For example, the support structure combines two structures into one, thereby requiring only one layer between an underlying subfloor and a main floor for support and heating. This single layer saves cost and installation time, eliminates the uneven main floor possibility, and avoids any cable exposure. No additional tools, skills, or materials are needed because the support structure is installed in the same way as commonly done. The support structure can be cut into any shape to accommodate any floor shape or obstacles. The multiple orientations and locations of the slots allow the heating cable to be placed in any configuration on the support structure, such that any floor shape can be heated. The support structure can adapt to last minute changes in layout of the heated flooring up until the main floor is laid. The support structure is safe for foot traffic during installation because the heating cable is safely protected by the support structure protrusions. The support structure also provides a thin lightweight structure easily handled and installed, thereby minimizing the mass of material needed to provide heating and floor support.

The support structure 100 may be flexible and may include any material, such as plastic, resin, or any suitable polymer, capable of supporting a floor and cables. In some examples, organic materials such as cork may be used. The support structure 100 may include a single material or a combination of different materials. Additionally, the materials used may provide for heat and sound insulation. A bottom layer (e.g., webbing) may also be provided to help promote bonding of the support structure 100 to an adhesive material.

The support structure 100 may be fabricated in several ways. For example, the support structure 100 may be fabricated using a molding method, in which molten material may be injected into a mold of the structure 100, where the mold includes elements to form the protrusions 120, the slots 130, and the cavities 110. When the material cools, the mold may open and eject the molded material. In some cases, multiple molds may be used, e.g., to step-wise form particular protrusions 110, slots 130, and cavities 110, where the molded material is cooled between each mold and ejected after the final mold. Or the support structure 100 may be fabricated using a pressing method, where a malleable material is stretched and pressed by machinery into a desired shape for the protrusions 120, the slots 130, and the cavities 110. Or the support structure 100 may be fabricated in the same way as the commonly used support structure of FIG. 1 and then the slots 130 made in the protrusions as described below. The fabricated support structure 100 may be wound into a roll or laid out in flat sheets.

The slots 130 of the support structure 100 may be fabricated in several ways. For example, as described above, the slots may be originally made as part of the support structure using, e.g., molding or pressing. Or, as described above, the slots may be made after the support structure is fabricated as follows. A cutting method may be used to cut away portions of the protrusions 120 to form the slots 130. Or a tunneling method may be used to tunnel through the protrusions 120 to form the slots 130. The slots 130 may be open from top to bottom of the protrusions 120 as shown in FIG. 2. Alternatively, the slots 130 may form tunnels through a mid-portion of the protrusions 120.

In some embodiments, the cavities are substantially identical in size and shape to each other. In other embodiments, the cavities are different in size and shape from each other. The shapes and sizes of the protrusions help define the size and shape of the cavities. In some embodiments, the slots are substantially identical in width and shape to each other. In other embodiments, the slots are different in width and shape from each other. The slots can be linear, curved, or a combination thereof and oriented horizontally, vertically, diagonally, or any combination thereof.

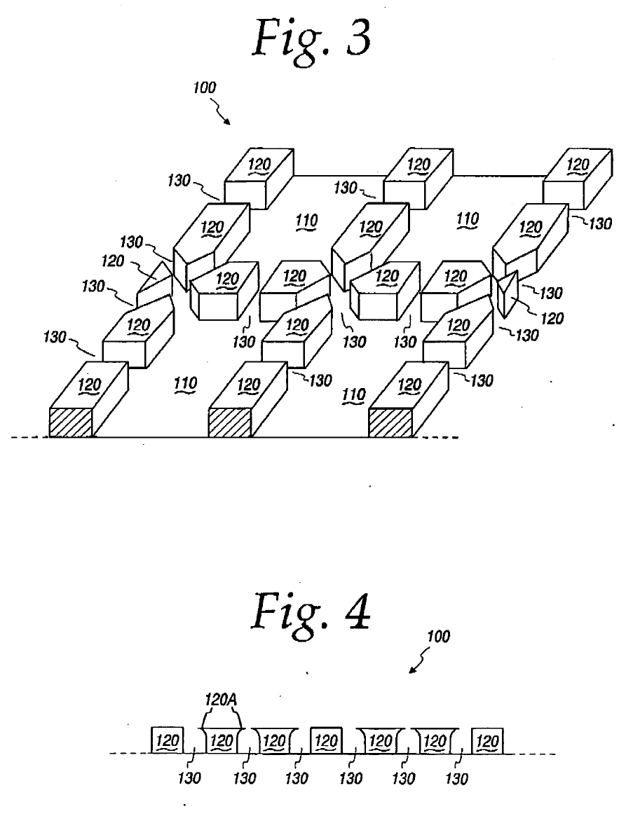

FIG. 3 is a diagram of a three-dimensional view of an example of the support structure of FIG. 2. Here, the slots 130 are clearly shown adjacent to the protrusions 120 as pathways to the cavities 110. The protrusions 120 are shown here as solid on the inside. The protrusions 120 may be solidly formed of a block of the support structure material or may be solidly filled with a filler. Alternatively, the protrusions 120 may be hollow or partially solid, if needed for a particular application.

FIG. 4 is a diagram of a side view of an example of the support structure of FIG. 2. Here, the protrusions 120 and the slots 130 are shown. To hold the cables within the slots 130, the protrusions 120 have small extensions 120A at the top of the protrusions 120 that overhang the slots 130 to provide a dove-tail configuration for the slots 130. This allows the heating cable to easily snap into the slot 130 but be constrained by the extensions 120A from snapping back out. Other types of constraints may be used to hold the cables in the slots 130, including, but not limited to, hooks, snaps, adhesives, tape, and any other elements capable of constraining a cable.

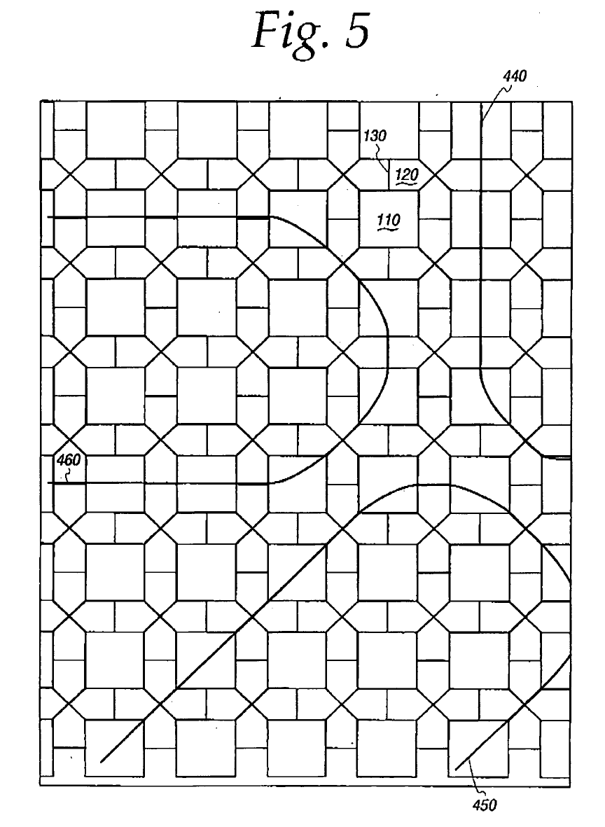

FIG. 5 is a diagram of a top view of an example of the support structure of FIG. 2 supporting cables therein. Here, cables 440, 450, and 460 are laid in the slots 130 of the support structure 100. Due to the different orientations and positions of the slots, the cables can be laid in any configuration desired for the appropriate placement and effect. Here, cable 440 is laid in a vertical pattern. Cable 450 is laid in a diagonal pattern. Cable 460 is laid in a horizontal pattern.

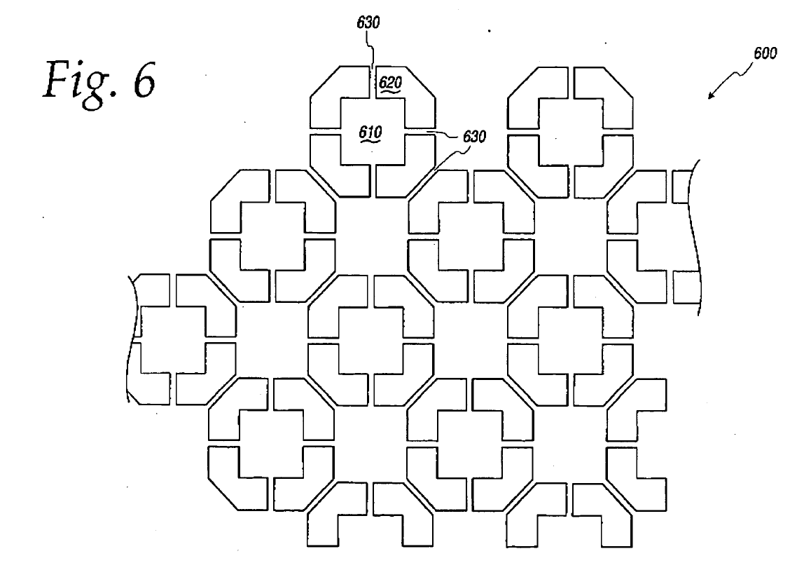

FIG. 6 is a diagram of a top view of an example of another support structure of the present disclosure that has single diagonal slots. The support structure 600 is the same as the support structure 100 of FIG. 2, except rather than have crossed diagonal slots 130, the slots 630 are single diagonals. Hence, the support structure 600 includes protrusions 620 extending from the surface in such a manner to form rectangular shaped cavities 610. Slots 630 are made adjacent to the protrusions 620 and oriented in multiple directions to allow cable to be laid in any configuration.

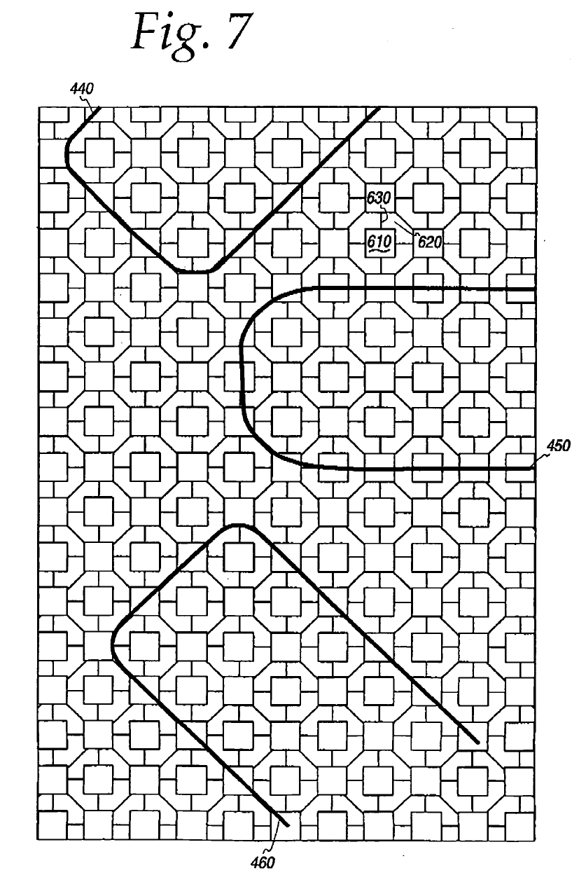

FIG. 7 is a diagram of a top view of an example of the support structure of FIG. 6 supporting cables therein. Here, cable 440 is laid in a diagonal pattern. Cable 450 is laid in a horizontal pattern. Cable 460 is laid in an opposite diagonal pattern.

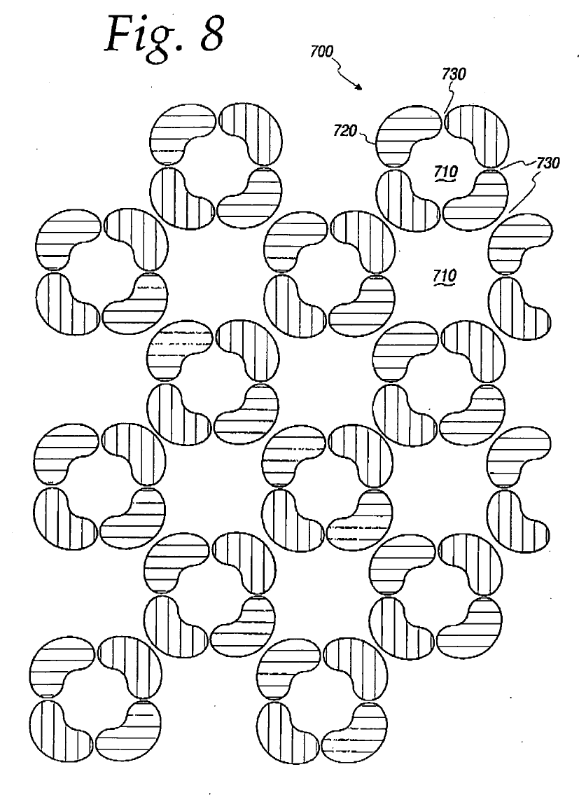

FIG. 8 is a diagram of a top view of an example of another support structure of the present disclosure that has curved protrusions and curved slots. The support structure 700 includes protrusions 720 with curved corners, the protrusions 720 extending from the surface in such a manner to form rectangular-like shaped cavities 710. Some of the cavities 710 are formed on the inner side of surrounding protrusions 720 and other cavities 720 are formed on the outer side of the surrounding protrusions 720. As a result, the protrusions 720 have different shapes and sizes. Slots 730 are made adjacent to the protrusions 720 with curved openings and oriented in multiple directions to allow cables to be laid in any configuration.

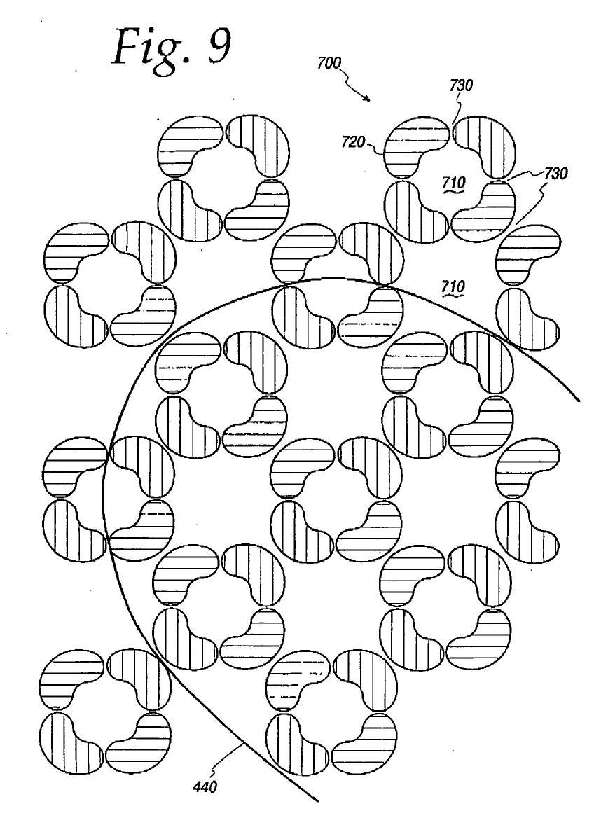

FIG. 9 is a diagram of a top view of an example of the support structure of FIG. 8 supporting a cable therein. Here, cable 440 is laid in a diagonal pattern.

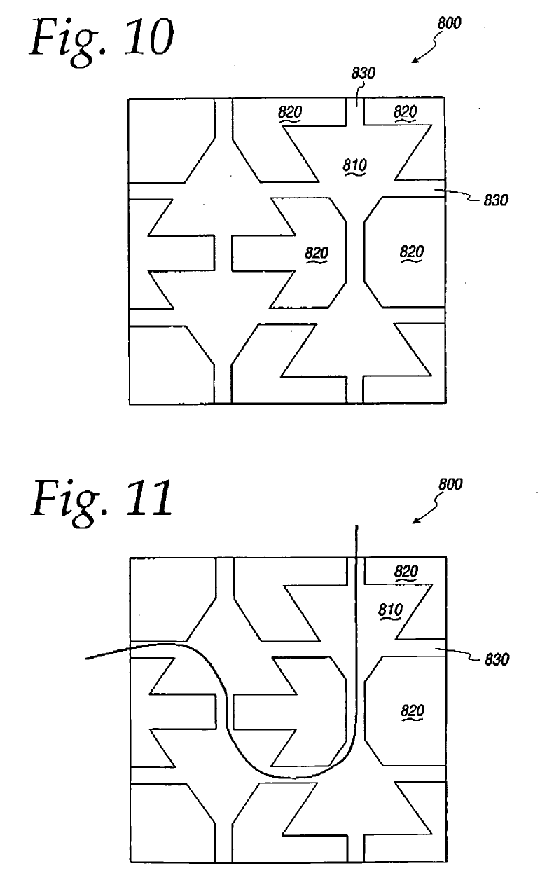

FIG. 10 is a diagram of a top view of an example of another support structure of the present disclosure that has triangular shaped cavities. The support structure 800 includes protrusions 820 extending from the surface in such a manner to form triangular shaped cavities 810. Slots 830 are made adjacent to the protrusions 820 and oriented in multiple directions to allow cable to be laid in any configuration.

FIG. 11 is a diagram of a top view of an example of the support structure of FIG. 10 supporting a cable therein. Here, cable 440 is laid in both a vertical and horizontal pattern.

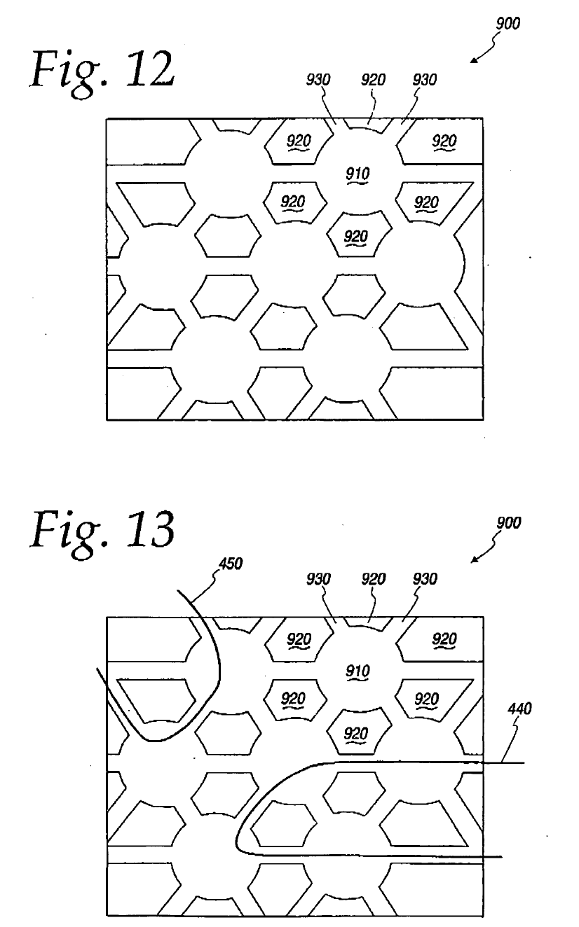

FIG. 12 is a diagram of a top view of an example of another support structure of the present disclosure that has circular shaped cavities. The support structure 900 includes protrusions 920 extending from the surface in such a manner to form circular shaped cavities 910. Slots 930 are made adjacent to the protrusions 920 and oriented in several directions to allow cable to be laid in any configuration.

FIG. 13 is a diagram of a top view of an example of the support structure of FIG. 12 supporting cables therein. Here, cable 440 is laid in a horizontal pattern. Cable 450 is laid in a diagonal pattern.

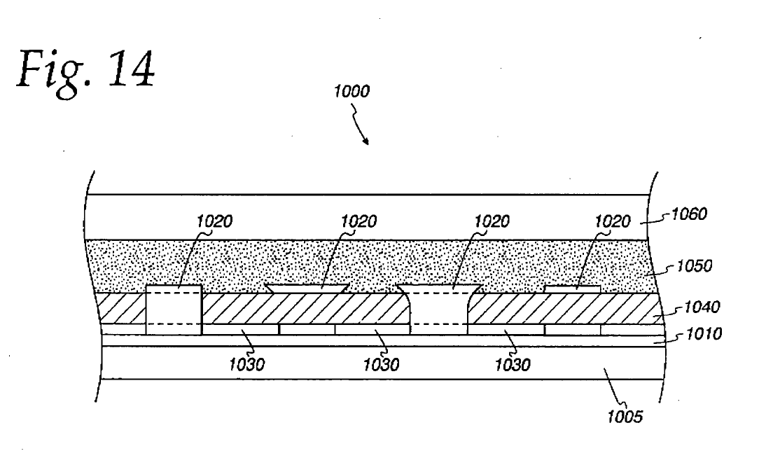

FIG. 14 is a diagram of an example of an installed floor including the support structure of FIG. 2. The support structure 1010 is disposed on a subfloor 1005 using any adhesive, fastener, or suitable means for fixing the structure 1010 to the subfloor 1005. A cable 1040 is laid into slots 1030 adjacent to protrusions 1020. The structure cavities are filled with a filler 1050, such as mortar, and the cable 1040 and structure 1010 are covered with the filler 1050. The main floor 1060 is laid on top of the filler 1050.

The support structure according to the present disclosure may also be used in walls, ceilings, and other structures to support them and to support heating cables in a similar way as described above regarding the support structure in the floor.

In addition to using the support structure to support heating cables, the structure may be used to support other types of cables. For example, audio cables may be laid to provide audio. Lighting cables may be laid to provide under-surface lighting. Security cables may be laid to provide motion or pressure detection. Electric fencing cables may be laid to provide invisible fencing for animals, for example.

Alternatively, the support structure may be used as an underlying support without cable. Or the support structure may be used to support discrete elements, e.g., sensors, tags, etc., within the slots that connect through wireless communication.

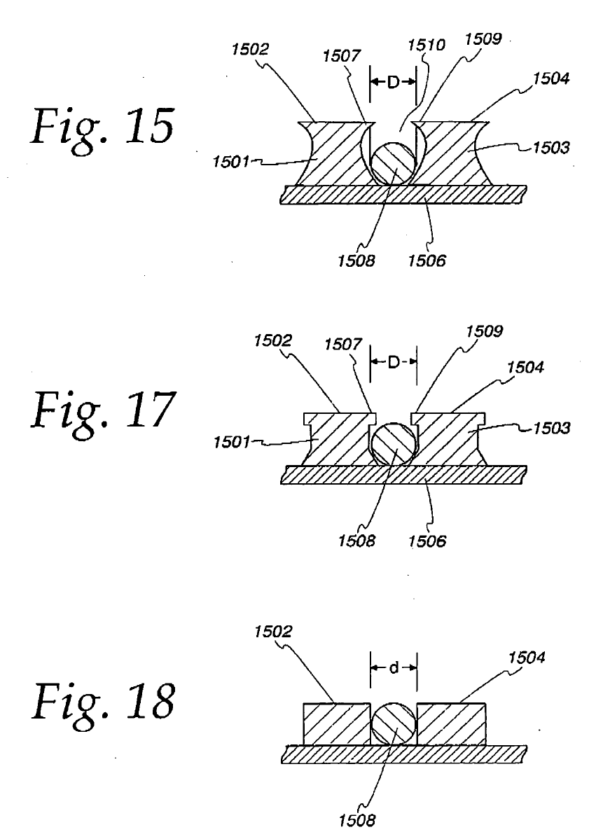

Referring now to FIGS. 15 and 16, another example of a support structure using the present approaches is described. The support structure includes a first protrusion 1502 and a second protrusion 1504 that extend from a surface portion 1506. The protrusions 1502 and 1504 have a generally T-shaped cross-section with protrusion upper portions 1507 and 1509 that extend from protrusion base portions 1501 and 1503. The protrusions 1502 and 1504 form a passageway 1510 there between. The protrusion upper portions 1507 and 1509 are separated by a distance d. A heating cable 1508 is disposed through and past the protrusion upper portions 1507 and 1509 and snapping into the passageway 1510. In one example, the heating cable 1508 is approximately ⅛ of an inch in diameter and the distance d is also ⅛ of an inch wide. However, the diameter of the heating cable 1508 and the distance d can be adjusted to suit the needs of the user or requirements of the system. Consequently, the protrusions are located proximally to each other and the proximate location of the protrusions (and their upper portions) constrain the movement of the heating cable out of the passageway.

Because the diameter of the heating cable 1508 is the same, nearly the same, or even slightly larger than the separation distance between the protrusion upper portions 1507 and 1509, the heating cable 1508 snaps into place within the passageway 1510. Additionally, the protrusion upper portions 1507 and 1509 act to constrain the heating cable 1508 in place since the distance between the upper portions 1507 and 1509 is nearly the same or smaller than the diameter of the heating cable 1508. Consequently, the heating cable 1508 will not lift out of the passageway 1510.

The shape and dimensions of the bottom portion of the passageway 1510 may be selected to aid in holding the heating cable 1508. In one example, the cross sectional shape of the bottom of the passageway 1510 substantially conforms to the shape of the heating cable (i.e., the shape of each of the bottom of the passageway 1510 and the heating cable 1508 may be substantially semi-circular in the cross section such that the heating cable fits snugly into the bottom portion of the passageway 1510).

The amount of play (e.g., extra space around the heating cable 1508 available for movement) available to the heating cable 1508 in the passageway 1510 may vary. In one example, extra space may exist around the heating cable 1508 at the bottom of the passageway 1510. In other examples, there may be little or no space around the heating cable 1508 (i.e., the heating cable has little or no room for movement in the passageway and the passageway substantially conforms to the shape of the heating cable 1508) thereby providing a tight fit (e.g., where there is little or know play available for the heating cable 1508).

The shape and dimensions of the upper portions 1507 and 1509 may vary. For example, referring now to FIG. 17, the upper portions 1507 and 1509 extend 1/16 of an inch from the base of the protrusions. In the example of FIG. 17, the heating cable 1508 fits tightly in the passageway 1510 and can not move out of the passageway 1510 since the distance d is the same or slightly smaller than the diameter of the heating cable 1508.

Regardless of their overall shape, in the examples of FIGS. 15-17, all sides of the protrusions have an undercut portion meaning that the top portion of the protrusion has a larger dimension than the underlying portion of the protrusion.

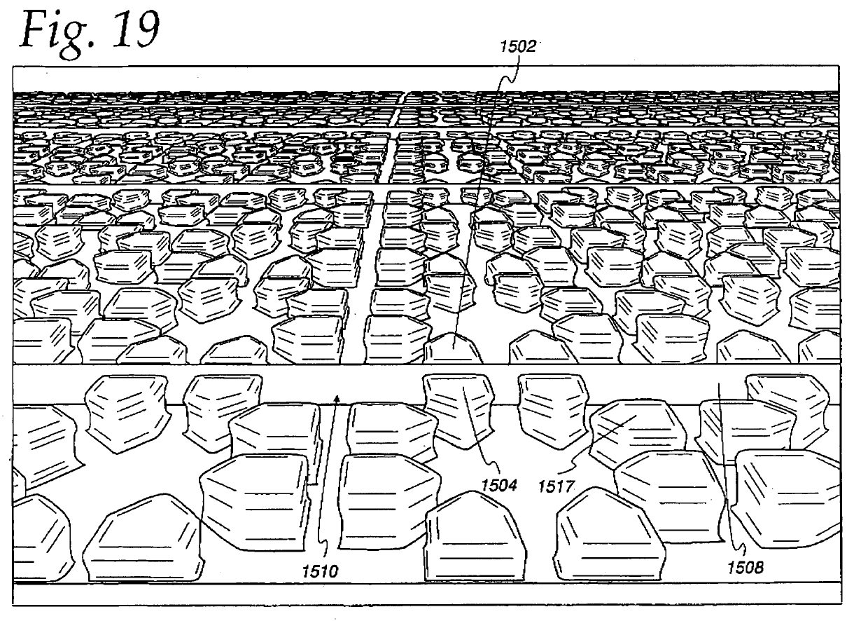

However, in some other examples, not all protrusions have an overhanging portion. For example, and now referring to FIG. 19, the protrusions 1502 and 1504 have overhanging portions allowing the heating cable 1508 to be secured in the passageway. Other protrusions, for example, a protrusion 1517, do not have overhanging portions. It will be appreciated that the selection of protrusions with or without overhanging portions will vary based upon the needs of the system and requirements of the user.

The dimensions and spacing of the protrusions may also vary. In one example, the protrusions are ¼ high, the upper portion overhangs the lower (base) portion of the protrusion by 1/16 of an inch, and the upper portions are separated by ⅛ of an inch. In some other examples, not all protrusions have upper portions separated by ⅛ of an inch (or other distance selected to secure the heating cable in the passageway). In other words, only some protrusions of the support structure may include an overhanging upper portion and other protrusions within the same support structure may omit this feature altogether. Consequently, the protrusions are located proximally to each other and the proximate location of the protrusions (and their upper portions) constrain the movement of the heating cable out of the passageway.

Referring once again to FIG. 16, the pathways provide a tight fit to hold the heating cable 1508 in place. As shown in other examples described herein, the heating cable winds through various passageways. Because of the overhanging upper portions that act to hold the heating cable in place, no additional fasteners, adhesives, or other materials to hold the heating cable in place are required.

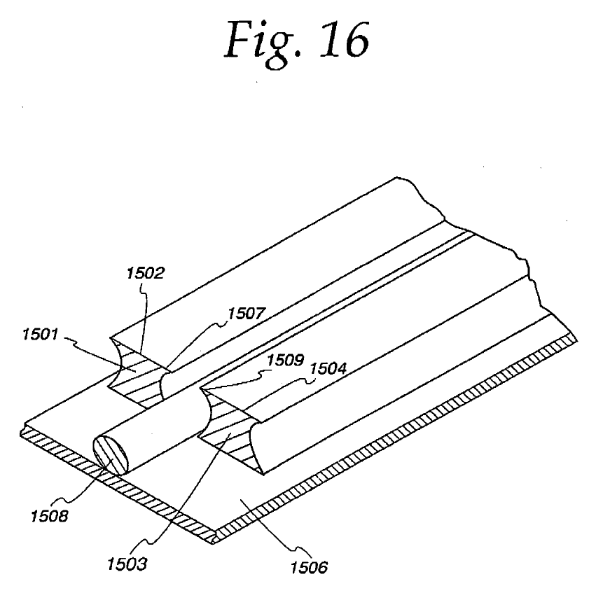

Now referring to FIG. 18, an example of a support structure having no over hanging protrusion upper portions is described. However, in this example, the protrusions are spaced a distance d from each other. The distance d is the same as or slightly smaller than the diameter of the heating cable 1508. Consequently, the heating cable 1508 is held in place in the passageway 1510 by the pressure of the sides of the passageway 1510 that is exerted on the heating cable 1508.

The surface portion and protrusions of the support structure can be constructed of various types of materials. For example, the mat and the protrusions may be composed of materials such as plastic, resin, or any suitable polymer, capable of supporting a floor and cables. In some examples, organic materials such as cork may be used. The materials may also be selected to provide for heat and sound insulation.

The protrusions are created from a material having sufficient flexibility and resiliency such that heating cables or other conduits will give to permit insertion between the protrusions even though the distance between the protrusions may be less that the diameter of the heating cable or other conduits and return to their pre-insertion location or thereabouts. Such flexibility and resiliency assists the snap-in functionality and avoids the need for labor and tool intensive on-site modifications to the protrusions. In other words, flexibility is provided in a horizontal direction (to allow insertion of the heating cables or other conduits) and not only in a vertical direction.

In many of these examples, the composition, shape, and configuration of the protrusions causes the support structures described herein to be extremely resilient in terms of wear of the tiles (or other flooring materials) that are supported by the support structure. To take one example, the composition, configuration, and/or shape of the support structure allows the support structure to flex thereby preventing damage (e.g., cracking) of the overlaying tiles (or other flooring material) from occurring.

Various kits can be utilized that allow a purchaser (e.g., a consumer) to purchase and then install the system in their home or business. In one example, the kit includes an electrical conductor and a support structure. The support structure includes a surface portion, a plurality of protrusions that extend from the surface that form a plurality of cavities and a plurality of openings adjacent to the protrusions that form passageways between the cavities.

In some of these examples, the protrusions are configured according to the examples of FIGS. 15-18. The kit can be conveniently packaged in a variety of different ways and its components can be stored in the package in any number of ways. Conveniently, the support structure (e.g., a mat) can be rolled and secured within the package. The support structure can be configured according to any of the approaches described herein.

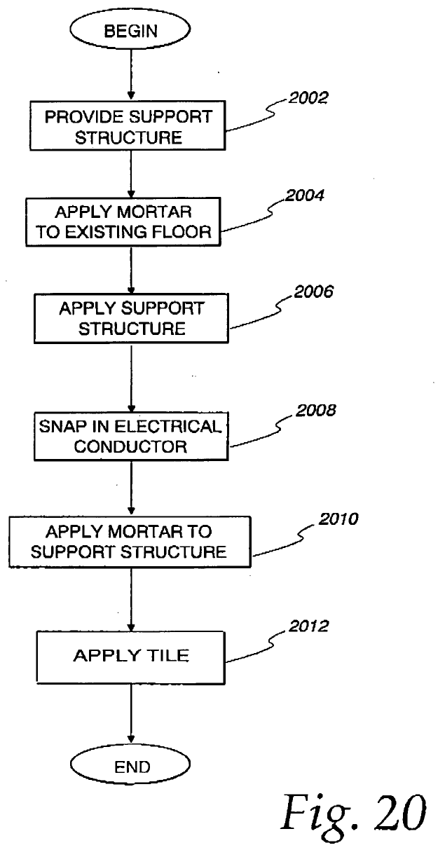

Referring now to FIG. 20, one example of a method for installing a support structure is described. At step 2002 a structure is provided. In one example, a customer can obtain a kit that includes the support structure. In one example, the support structure so provided includes a surface and a plurality of protrusions that extend from the surface to form a plurality of cavities there between, and a plurality of openings adjacent to the protrusions to form passageways between the cavities. In some of these examples, the support structure includes protrusions configured according to the examples of FIGS. 15-19.

At step 2004, an adhesive (e.g., a thin set mortar) is applied to the existing floor. At step 2006, the support structure is placed on top of an existing flooring on top of the adhesive. In one example, the support structure is rolled into place and is secured to the adhesive by pressing the support structure towards the existing floor.

At step 2008, at least one electrical conductor is snapped or otherwise placed in between the cavities in the support structure. A filler material may be used to fill in the gaps of the support structure. For example, a mortar may be used as a filler material. At step 2010, a second layer of adhesive is applied on top of the support structure. In one example, a thinset mortar is used. At step 2012, tile may be placed on top of the second mortar layer. The heating cable may be connected to a thermostat or an electrical power source. Alternatively, the heating cable may be electrically connected immediately after being installed in the support structure.

It is to be understood that the support structure is not limited to those illustrated in the above figures, but may include any protrusion, cavity, and/or slot shape, configuration, and/or orientation capable of providing the floor support and cable support functionalities according to the present disclosure.

The present disclosure is not limited to the configurations of the support structure described here, but rather may include any configuration capable of supporting floors and cables in accordance with the teachings of the present disclosure.

What is claimed is:

1. A support structure for a flooring material comprising:
a surface portion;
a first protrusion extending from the surface portion, the first protrusion having a first base portion extending from the surface portion the first base portion defining a first upper portion, the first upper portion overhanging the first base portion;
a second protrusion extending from the surface portion, the second protrusion adjacent to the first protrusion, the second protrusion having a second base portion extending from the surface portion and defining a second upper portion, the second upper portion overhanging the second base portion, and wherein and the second upper portion is separated from the first upper portion by a proximal separation distance;
a heating conductor having a diameter, the diameter being the same or greater than a length of the proximal separation distance such the heating conductor is configured to snap through the proximal separation distance into a passageway formed between the first protrusion and the second protrusion.

2. The support structure of claim 1 wherein the shape of the passageway substantially conforms to the heating conductor.

3. The support structure of claim 1 wherein the protrusions are constructed from a flexible material.

4. The support structure of claim 1 wherein the protrusions comprise a substantially T-shaped cross section.

5. A heated floor support construction kit comprising:
an electrical conductor;
a support structure, the support structure comprising:
a surface;
a plurality of protrusions that extend from the surface to form a plurality of cavities there between, at least some of the plurality of protrusions having adjacent upper portions; and
a plurality of openings adjacent to the protrusions to form passageways between the cavities and wherein the distance between at least some of the adjacent upper portions is the same or less than a diameter of the electrical conductor.

6. The kit of claim 5 wherein the electrical conductor comprises a cable.

7. The kit of claim 5 wherein the support structure comprises a flexible material.

8. The kit of claim 5 wherein the plurality of openings of the support structure comprise slots extending from the top of the plurality of protrusions to the surface.

9. The kit if claim 8 wherein the plurality of slots are substantially identical in width with one another.

10. The kit of claim 5 wherein the plurality of openings of the support structure are oriented in at least one of a horizontal direction, a vertical direction or a diagonal direction.

11. The kit of claim 5 wherein the plurality of openings of the support structure comprise at least one of a linear or circular configuration.

12. The kit of claim 5 wherein each of the plurality of protrusions of the support structure are substantially identical in size with respect to the other.

13. The kit of claim 5 wherein the plurality of protrusions of the support structure extend from the surface in substantially the same direction.

14. The kit of claim 5 wherein at least some of the plurality of cavities of the support structure form geometric shapes.

15. The kit of claim 5 wherein at least some of the plurality of cavities of the support structure are substantially rectangular in shape.

16. The kit of claim 5 wherein at least some of the plurality of cavities of the support structure are substantially circular in shape.

17. The kit of claim 5 wherein at least some of the cavities of the support structure are substantially identical in size to one another.

18. A method of installing a flooring system comprising:
applying a first adhesive material on top of an existing floor structure;
laying a support structure on top of the adhesive material;
laying the support structure on top of an existing floor structure;
forcing a heating conductor between a first upper portion of a first protrusion and a second upper portion of a second protrusion of the support structure, such that the heating conductor snaps into a passageway formed between the first protrusion and the second protrusion and is secured in place at least in part by proximal positioning of the first upper portion and the second upper portion;
applying a second adhesive material on top of the support structure;
laying a flooring element on top of the second adhesive material.

19. The method of claim 18 further comprising coupling a thermostat to the at least one electrical conductor.

20. The method of claim 18 further comprising activating the thermostat to heat the existing flooring.

21. The method of claim 18 wherein the first adhesive material and the second adhesive material comprise a mortar.

22. The method of claim 18 wherein the flooring element comprises tile.
